(19) United States
(12) Patent Application Publication
(10) Pub. No.: US 2016/0089792 A1
(43) Pub. Date: Mar. 31, 2016

(54) Magnetically Attached End Effectors

(71) Applicant: Tactile Automation, Inc., Monroe, WA (US)

(72) Inventors: Troy William Ojalehto, Monroe, WA (US); Timothy Allen Wright, Sultan, WA (US); Robert Thomas Perry, Seatac, WA (US)

(21) Appl. No.: 14/865,468

(22) Filed: Sep. 25, 2015

Related U.S. Application Data
(60) Provisional application No. 62/056,485, filed on Sep. 27, 2014.

(51) Int. Cl. B25J 15/04; B25J 15/00; B25J 9/02; G06F 3/041

(52) U.S. Cl. CPC B25J 15/0441; G06F 3/0418; B25J 15/0408; B25J 15/0009; B25J 15/0491; B25J 9/023; Y10S 901/30; Y10S 901/50; Y10S 901/16

(57) ABSTRACT

In implementations of magnetically attached end effectors, end effectors for use with a robotic touchscreen testing apparatus are held in a rack. The apparatus is able to fix, remove, and change end effectors though movement of a movable spindle of the apparatus relative to the rack. The end effectors are attached to the spindle through magnets and aligned with the spindle through complimentary alignment features on the end effectors and the spindle.

### CROSS REFERENCE TO RELATED APPLICATIONS

This application claims priority under 35 U.S.C. 119(e) to U.S. Provisional Patent Application No. 62/056,485, filed Sep. 27, 2014 and entitled “MAGNETICALLY COUPLED MECHANICAL AND ELECTRICAL ROBOTIC END EFFECTORS AND AUTOMATIC ROBOTIC END EFFECTOR CHANGING MECHANISMS AND ALIGNMENT PROCESSES” by Ojalehto et al., which is incorporated by reference in its entirety herein.

### BACKGROUND

Touchscreen devices are increasingly common, and the functionality associated therewith is also increasingly complex. For example, most mobile computer devices have touchscreens that allow single and multi-touch gestures through high-resolution position and pressure data. Traditional testing of these devices required a user to interact with the devices and relied on user feedback to determine the effectiveness of a touchscreen. More recently, specialized pieces of robotic equipment have been employed to test touchscreens, however they utilize single end effectors that are both complicated and time consuming to change. Current end effectors and methods of attaching and controlling them are not cost effective to produce, require a high level of precision, and may cause damage to the robot or work piece and loss of process control if work piece variance or robot programming error is encountered. Additional electronics or other components may be required to generate certain actions of the end effectors such as pinching and spreading.

There often also exists a need to change the end effectors to achieve different types of touchscreen testing. End effector gestures can include pinching, spreading, tapping, rotating, linear or circular interactions, and verification of alignment with the work piece. Pneumatic, hydraulic, and spring force end effector changers add complexity to the system. They may also require high precision to operate and don't automatically uncouple under side loads from incorrect operation. Adding effector axes and alignment methods to these effector changers require additional electronics at increased cost. These devices are costly, complex, and require high precision to function.

### SUMMARY

This summary is provided to introduce simplified concepts of magnetically attached end effectors that are further described below in the Detailed Description. This summary is not intended to identify essential features of the claimed subject matter, nor is it intended for use in determining the scope of the claimed subject matter.

Magnetically attached end effectors are described. Magnets are utilized along with mechanical registration and friction of alignment features to provide a cost effective means of changing end effectors and adding additional axes to the end effectors without the need for additional electronics, pneumatics, or control channels. The coupling method provides precise end effector alignment through mating surfaces and walls while also allowing for significant system inaccuracies due to a self-aligning action of the alignment features and a spring action of an end effector holding rack. The magnetic coupling also provides a method of calibrating axes and ensures safe uncoupling if unexpected forces caused by process errors are encountered.

In implementations, end effectors to be used for touchscreen testing are stored in the end effector holding rack, and a robot is able to fix, remove, and change the end effectors solely attached thereto by movement of the robot relative to the rack. The end effectors have tips that are able to mimic a variety of gestures including single touch gestures such as tap and drag gestures as well as multi-touch gestures such as pinch and pull gestures. The end effectors are attached to a spindle of the robot by magnetism and aligned with the spindle through mechanical features.

The rack contains mechanical features that allow the robot to position an attached end effector into the rack, index the end effector in the rack, hold the end effector in the rack as the robot moves to detach the end effector, and enable the robot to pick up another end effector. Fixing, removing, and changing end effectors is able to be accomplished through simple Cartesian movement of the robot with no other means necessary.

### BRIEF DESCRIPTION OF THE DRAWINGS

Implementations of magnetically attached end effectors are described with reference to the following drawings. The same numbers are used throughout the drawings to reference like features and components:

FIG. 1 illustrates an example of a robotic touchscreen testing apparatus including a robot, end effectors, and a rack for the end effectors in accordance with one or more implementations.

FIG. 2 illustrates an example of an end effector as described with reference to FIG. 1 that includes magnetic attachment features, alignment features, and a single finger mimicking tip in accordance with one or more implementations.

FIG. 3 illustrates an example of a head of the robot as described with reference to FIG. 1 with a spindle for attaching end effectors thereto in accordance with one or more implementations.

FIG. 4 illustrates an example of a rack to hold the end effectors as described with reference to FIG. 1 in accordance with one or more implementations.

FIG. 5 illustrates an example of an end effector holder of the rack as described with reference to FIG. 4 in accordance with one or more implementations.

FIG. 6 illustrates example method(s) of attaching an end effector to the spindle of the robot in accordance with one or more implementations.

FIG. 7 illustrates example method(s) of changing an end effector attached to the spindle of the robot in accordance with one or more implementations.

### DETAILED DESCRIPTION

### Overview

Magnetically attached end effectors are described. In implementations, a robot, such as a multi-axis robot or gantry system, is able to fix, remove, and change end effectors solely by movement of the robot. The end effectors are fixed to a spindle that is part of a movement head of the robot by magnetism and aligned to the spindle by mechanical alignment features. The mechanical alignment features align the end effectors to the spindle while magnetism keeps the end effectors adhered to the spindle.

Magnetically attached end effectors provide precision coupling, safe uncoupling, and additional axes for the robot, with a simple and cost effective design without the use of ancillary equipment such as pneumatics, electronics, or machine vision. The beveled design with its magnetic coupling and rack mounting are a simple way of achieving safe, high precision effector changes. The system also allows the addition of end effector axes such as pinching and spreading without additional control channels. An automatic alignment procedure can be used in conjunction with the end effector to verify system alignment without the need for machine vision.

While features and concepts of the described systems and methods for magnetically attached end effectors can be implemented in any number of different environments, systems, devices, and/or various configurations, implementations of magnetically attached end effectors are described in the context of the following example devices, systems, and configurations.

### DESCRIPTION OF THE DRAWINGS

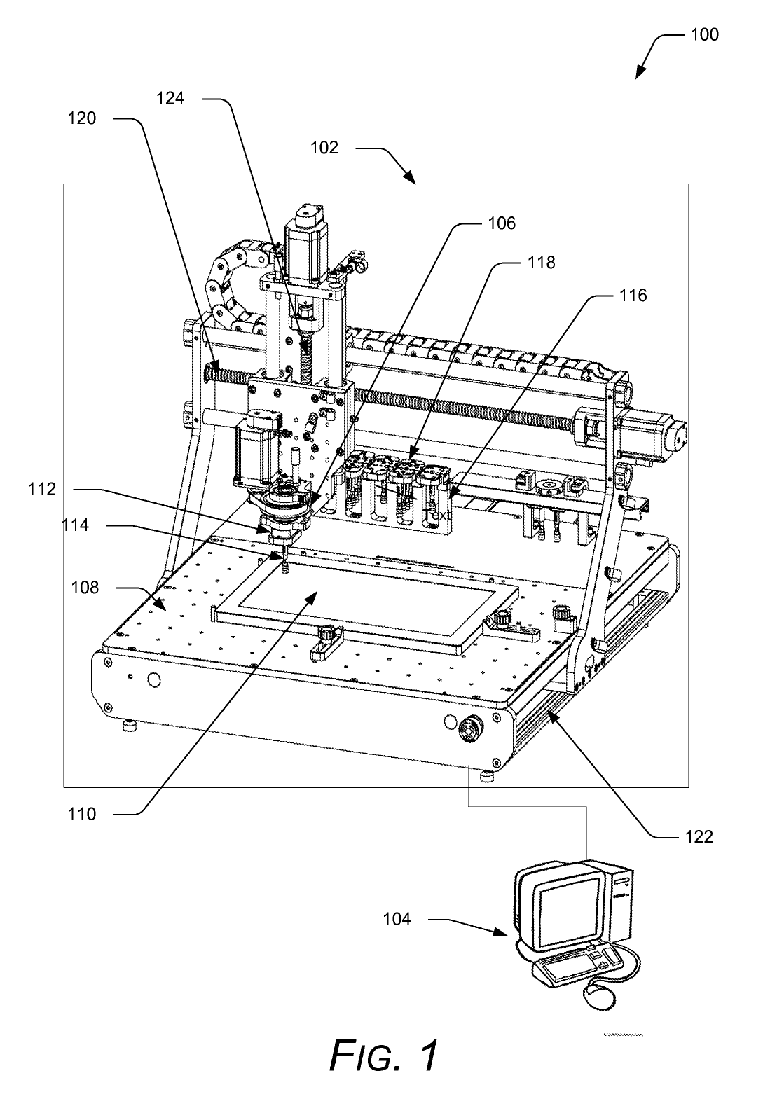

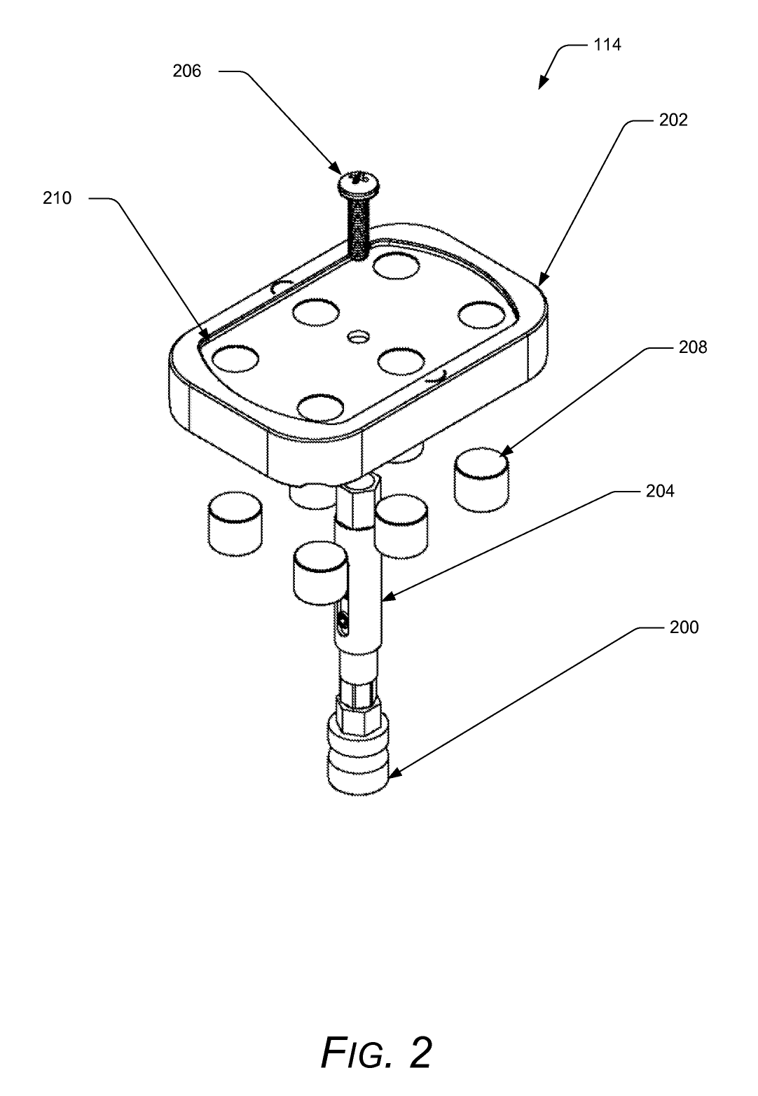

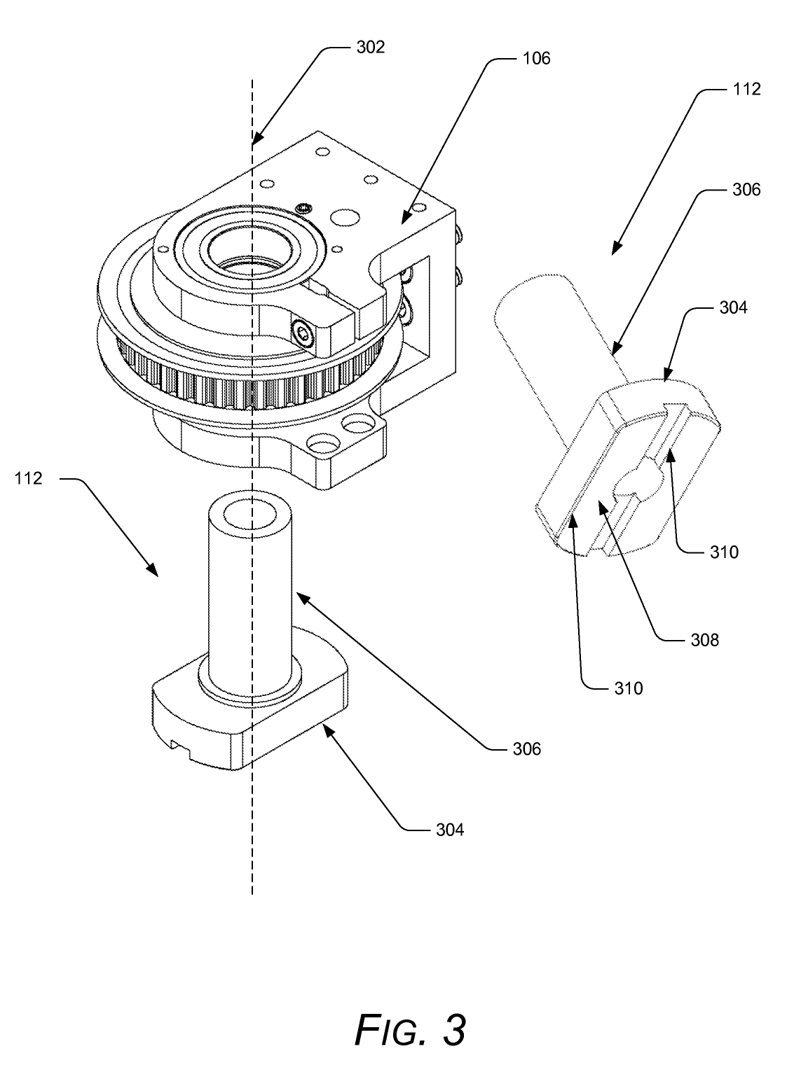

FIG. 1 illustrates an example of a robotic touchscreen testing apparatus 100 that includes a robot 102 coupled to a computer 104 with one or more implementations. The robot is shown as a 4 axis gantry robot with a robot head 106, however, the robot can be any robotic apparatus with a robot head 106 capable of movement relative to a table 108 of the robot 102. A touchscreen device 110 to be tested is secured to the table 108 of the robot 102. The robot head 106 contains a spindle 112 that is able to move in three Cartesian coordinates relative to the table 108 as well as rotate on an axis normal to the table 108. The rotation of the spindle 112 is used to rotate the end effector 114 that is attached to the spindle 112 however the rotation of the spindle is not needed to fix, remove, or change the end effector 114. The rotation of the spindle 112 is also used to manipulate an end effector 114 that is configured for pinch and spread gestures that is further described with reference to FIG. 2. The end effector 114 is fixed to the spindle 112 by magnetism. This may be achieved by having magnets within the spindle 112 or by having one or more magnets within the end effector 114. The end effector 114 is aligned with the spindle 112 through alignment features. The magnets and alignment features are further described with reference to FIGS. 2 and 3.

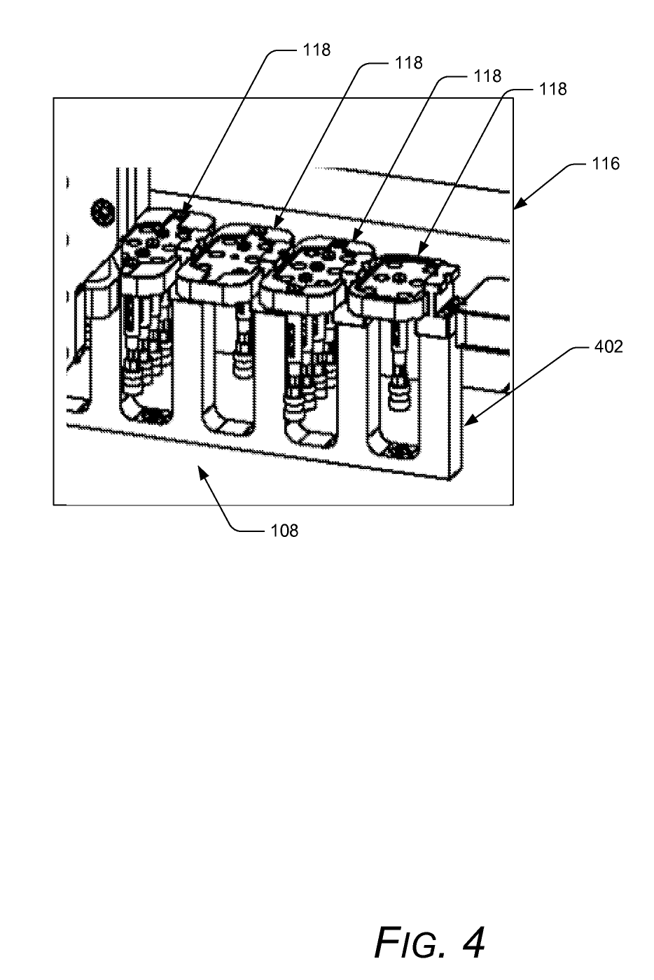

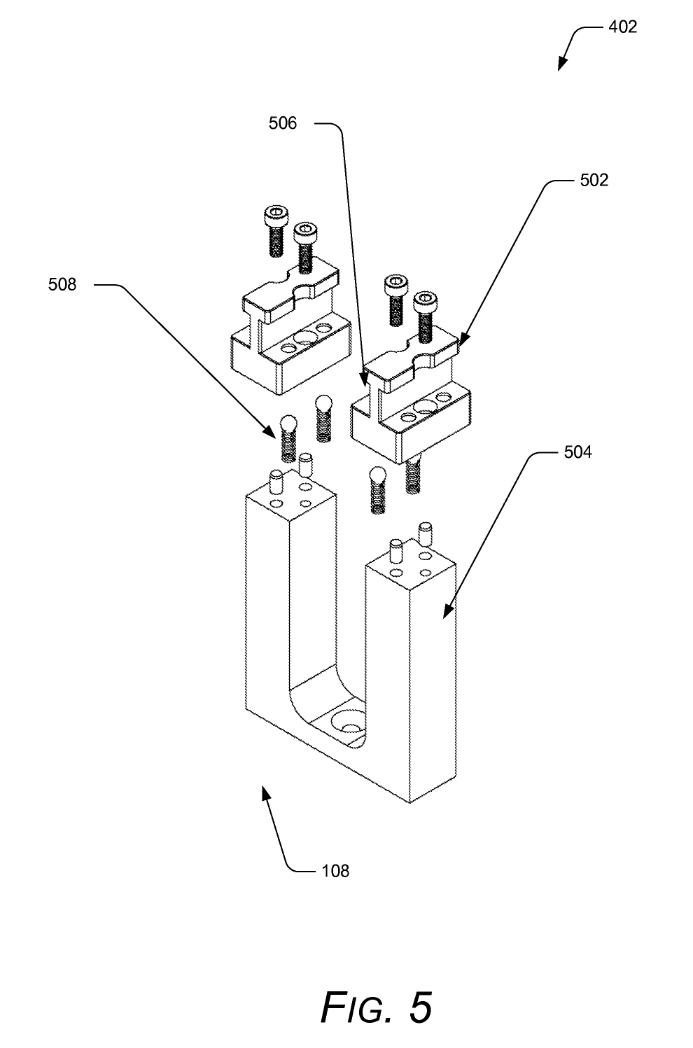

The robot 102 also contains a rack 116 that is further described with reference to FIGS. 4 and 5. The rack 116 holds one or more other end effectors 118 that are able to be fixed to the spindle 112 through movement of the robot 102.

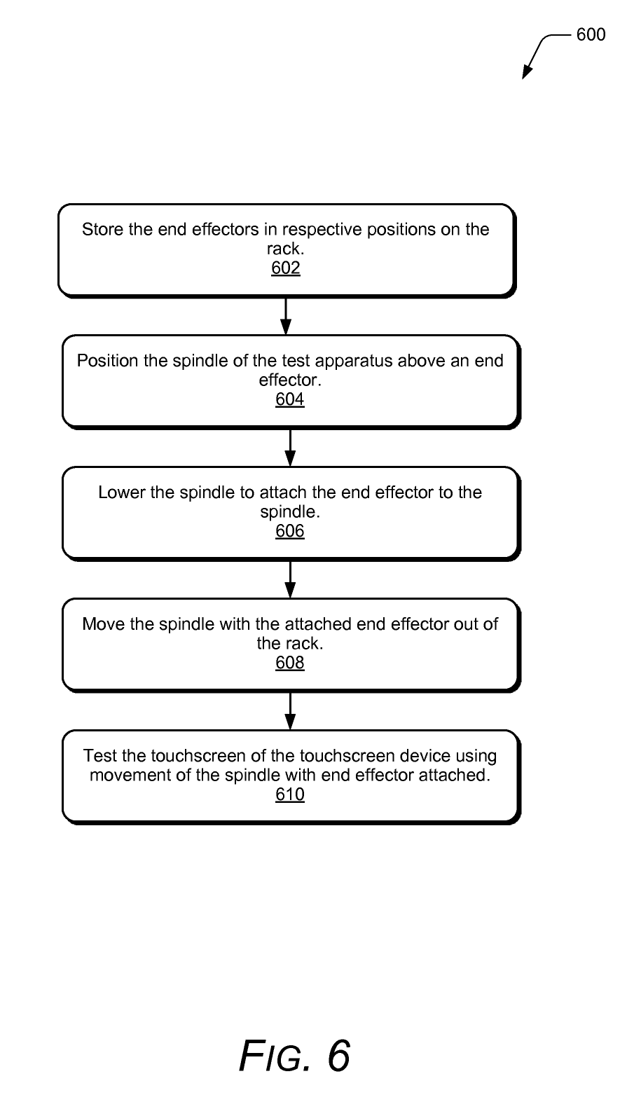

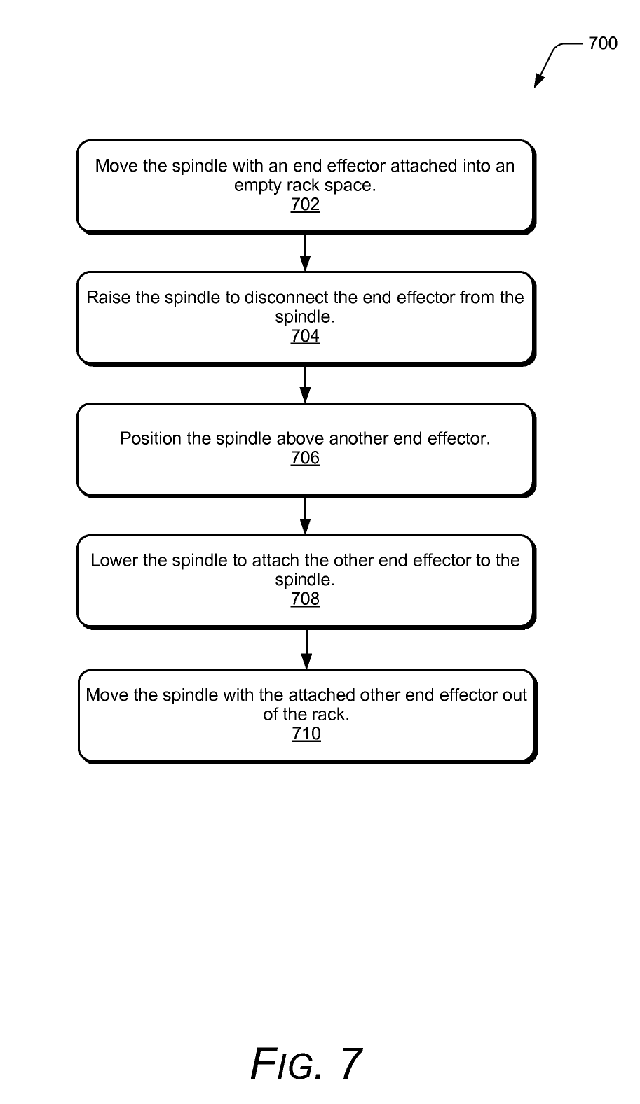

The movement of the robot is referred to in an x-direction 120, a y-direction 122, and a z-direction 124. The x-direction 120 and y-direction 122 make a plane parallel to the table 108 and touchscreen device 110. The z-direction 124 is defined as a “height” above the touchscreen device 110 and is used to start and stop touch inputs as well as fix, remove, and change end effector 114 as will be discussed with reference to FIGS. 6 and 7.

FIG. 2 further illustrates the end effector 114 of the robot 102 described with reference to FIG. 1. FIG. 2 shows the end effector 114 as a single tip end effector. That is, that the end effector has a single tip 200 which is meant to mimic a single human finger. The end effector 114 can contain a variety of tip configurations including single, double, triple, quadruple, quintuple, or any other human finger mimicking setups. The double tip configuration may comprise a moving rack and pinion system that allows the robot 102 to mimic a spread or pinch gesture through movement of the tips relative to the spindle. This may be achieved through the rotation of the spindle 112 or by some other means. The end effector 114 may also be able to mimic a tapping gesture on one or more tips by thrusting tips away from the body of the end effector 114 by pneumatic or electric solenoids.

The end effector 114 contains a connection portion 202, a body 204, and the tip 200. The tip 200 is meant to mimic a human finger when placed against the touchscreen device 110. The tip 200 is secured to the body 204 through bolting, threading, snapping, or any other means. The body 204 contains a spring that enables the tip 200 to move relative to the body 204 along a major axis of the body. This enables a touch force to be controlled through movement of the robot 102 in the z-direction 124 relative to the touchscreen device 110. Attached to the body 204 is the connection portion 202. The connection portion 202 is held to the body through bolt 206. Although a single bolt 206 is shown, connection portion 202 may be secured to body 204 through more than one bolt, threading, snapping, or any other means.

Connection portion 202 contains magnetic attachment features 208 and alignment features 210. The magnetic attachment features 208 can be one or more magnets placed within the connection portion 202 that are attracted to the spindle 112 of the robot. The magnetic attachment features 208 can also be one or more ferrous pieces placed within the connection portion 202 that are attracted to one or more magnets placed within the spindle 112 of the robot. It is also a possibility that the entire connection portion 202 be ferrous to be attracted to the one or more magnets within the spindle. In a preferred implementation, the magnetic attachment features are rare-earth magnets designed to be attracted to the spindle 112 that is made of a ferrous material. The magnetic attachment features 208 are shown as a group of magnets arranged evenly around the connection portion 202 enabling an even attraction force to the spindle 112. Any number of magnetic attachment features can be used to cause an attraction of the connection portion 202 to the spindle 112 along the major axis of the body 204.

The alignment features 210 allow the connection portion 202 to be aligned with complimentary alignment features on the spindle 112. The alignment features 210 also take up minor amounts of misalignment between the connection portion 202 and the spindle 112 during fixing and changing of the end effector 114 to the robot 102 ensuring that the end effector 114 is always in the same location relative to the spindle 112. The alignment features 210 are shown as a lead in chamfer around the perimeter of the connection portion. The alignment features 210 may also comprise one or more of filets, bosses, recesses, pins, tapers, protrusions, or cutouts. Depending on the alignment features 210 of the connection portion 202 the spindle 112 has complimentary alignment features that complement the alignment features 210 of the connection portion of the end effector 114. For example, the alignment features 210 are shown as a recessed section with an internal chamfer around the perimeter the recess. A complimentary alignment feature on the spindle 112 would be a positive raised section with an external chamfer of the same size, shape, and perimeter as the internal chamfer of the connection portion 202. Complimentary alignment features of the spindle with respect to the alignment features 210 shown in FIG. 2 are shown with respect to FIG. 3. Another example would be a protrusion on the connection portion 202 and a complimentary recessed portion on the spindle that surrounds the protrusion. A variety of other features on the connection portion 202 and complimentary features on the spindle 112 are envisioned.

FIG. 3 further illustrates the robot head 106 and spindle 112 of the robot 102 described with reference to FIG. 1. The robot head 106 moves in the three directions relative to the table discussed above with reference to FIG. 1. The spindle 112 rotates on a major axis 302 relative to the robot head 106. The rotation of the spindle 112, as discussed above, allows movement of tips of a pinch/pull type end effector relative to the robot head 106 as well as rotation of the end effector 114 relative to the spindle 112. It is noted that the rotation of the spindle 112 is not needed to fix, remove, or change end effector 114. The spindle 112 contains a spindle connection portion 304 and a spindle body 306. The spindle body 306 is attached to the robot head 106 and facilitates rotation of the spindle 112 relative to the robot head 106. The spindle connection portion 304 is shown as part of the spindle body 306, though the spindle connection portion 304 can be bolted, threaded, snapped, or connected to the spindle body 306 through any other fastening means.

Spindle connection portion 304 contains spindle magnetic attachment features 308 and spindle alignment features 310. The spindle magnetic attachment features 308 can be one or more magnets placed within the spindle connection portion 304 that are attracted to the end effector 114. The spindle magnetic attachment features 308 can also be one or more ferrous pieces placed within the spindle connection portion 304 that are attracted to one or more magnets placed within the end effector 114, as discussed in reference to FIG. 2. In a preferred implementation, the entire spindle 112 or entire spindle connection portion 304 be ferrous to be attracted to the one or more magnets within the end effector 114.

The spindle alignment features 310 allow the spindle connection portion 304 to be aligned with the alignment features 210 on the spindle 112. As discussed in reference to FIG. 2, the spindle alignment features 310 take up minor amounts of misalignment between the spindle connection portion 304 and the end effector 114 during fixing and changing of the end effector 114 to the robot 102 ensuring that the end effector 114 is always in the same location relative to the spindle 112. The spindle alignment features 310 are shown as a male type lead in chamfer around the perimeter of the spindle connection portion 304 as well as a slot for the head of the bolt 206. The spindle alignment features 310 are designed to complement the alignment features 210 comprising the female lead in chamfer around the perimeter of the connection portion 202 of the end effector 114. The spindle alignment features 310 may also comprise one or more of filets, bosses, recesses, pins, tapers, protrusions, or cutouts to compliment the alignment features 210 of the end effector 114. Complimentary features between the spindle 112 and end effector 114, as discussed with reference to FIG. 2, are mating surfaces that match shape but are generally opposites and may comprise positive/negative features, protrusions/recessions, male/female shapes, bolt heads/slots, etc.

FIG. 4 further illustrates the rack 116 of the robot 102 described with reference to FIG. 1. The rack 116 contains a plurality of end effector holders 402 that are further described with reference to FIG. 5. The rack 116 is able to hold one or more other end effectors 118 for use with the robot 102. Although end effector 114 is shown as a single digit end effector and other end effectors 118 are shown as multi-digit end effectors, the order and location of the end effectors is arbitrary. The rack 116 is secured to the table 108 and enables the end effectors to be fixed, removed, or switched from the robot 102 solely through movement in two directions of the robot head 106 relative to the rack 116. The rack 116 supports end effectors by the connection portion 202 as will be discussed further with respect to FIG. 5.

FIG. 5 further illustrates the end effector holder 402 of the rack 116 described with reference to FIG. 4. The end effector holder 402 contains slotted portions 502 that are attached to a base 504 that is attached to the table 108. The slotted portions 502 have slots 506 that are slightly taller than the connection portion 202 allowing the connection portion 202 to be supported by the slots 506 but still be able to slide within the slots 506. The distance between the slotted portions 502 is also such that that connection portion 202 is able to slide within the end effector holder 402 yet still have the connection portion 202 supported by the end effector holder 402. The distance between the slotted portions 502 is such that the spindle connection portion 304 does not interact with the slotted portions 502 when the end effector 114 is attached or removed from the spindle 112. The slotted portions 502 contain material that overhangs above the connection portion 202 of the end effector 114. This enables the robot 102 to move in the z-direction 124 while an end effector is in the end effector holder 402 disengaging the connection portion 202 from the spindle connection portion 304. The slotted portions 502 allow an end effector to moved in one direction (parallel to the slot) to slide into and out of the slotted portions 502 while allowing the end effector 114 to be fixed or removed from the spindle 112 by movement normal to the one direction (normal to the slot).

The slotted portions 502 contain indexing features 508 that keep the end effectors secured in the rack 116. The indexing features 508 may be ball detents with springs attached to them that engage depressions within the connection portions 202 of the end effectors. The indexing features 508 are able to move when an end effector slides in and out of the end effector holder 402 but secure the end effector enough that it will not move without the spindle 112 attached to it.

FIG. 6 illustrates example method(s) 600 of connecting the end effector 114 to the spindle 112 when the end effector 114 is on the rack 116 and no end effector 114 is attached to the spindle 112. One advantage of method 600 is that the end effector 114 can be attached to the spindle 112 merely through movement of the robot head 106 in two directions. The robot 102 need only move down towards the table 108 and out in the direction of the slots 506 to attach the end effector 114 and move out of the rack 116 with the end effector 114 attached to the spindle 112. The order in which the method blocks are described are not intended to be construed as a limitation, and any number of the described method blocks can be combined in any order to implement a method, or an alternate method.

At block 602, the end effector 114 is stored within the rack 116 and there is no end effector attached to the spindle 112. Other end effectors 118 may be stored within the rack 116 as well.

At block 604, the robot 102 moves the robot head 106 such that the spindle 112 is positioned directly above the end effector 114 in the rack 116. The spindle 112 is rotated such that the alignment features 202 on the end effector 114 and the spindle alignment features 310 of the spindle 112 are relatively aligned. If the robot 102 does not use a rotation axis of the spindle 112 there is no need to rotate the spindle 112 because it will always be relatively close.

At block 606, the robot 102 moves the robot head 106 down such that the spindle 112 is lowered to engage the magnetic attachment features 208 of the end effector 114 in the rack 116 to the spindle magnetic attachment features 308 of the spindle 112. The magnetic attachment and alignment of the end effector 114 to the spindle 112 occurs simultaneously when the robot head 106 is manipulated down towards the end effector 114 in the rack 116. At the end of block 606 the end effector 114 is attached to and aligned with the spindle 112.

At block 608, the robot 102 moves the robot head 106 in the direction of the slots 506 such that the spindle 112 with the end effector 114 attached are able to be removed from the rack 116. The indexing features 508 move relative to the slots 506 when the spindle 112 is moved in the direction of the slots 506. At the end of block 608 the spindle 112 has the end effector 114 attached thereto and the end effector 114 is clear of the rack 116.

At block 610, the robot 102 is able to move the spindle in any of the 4-axes described with reference to FIG. 1. to test the touchscreen device with the end effector 114. As mentioned earlier, if the 4-th axis (rotation of the spindle) is not used the robot 102 can move the spindle 112 in any of the three Cartesian coordinates described with reference to FIG. 1.

FIG. 7 illustrates example method(s) 700 of removing end effector 114 from the spindle 112 and attaching another end effector 118 to the spindle 112. One advantage of method 700 is that the end effector 114 can be switched to another end effector 118 stored in the rack 116 merely through movement of the robot head 106 in two directions. The robot 102 need only move up and down relative to the table 108 and in and out in the direction of the slots 506 to remove the end effector 114, attach another end effector 118 from the rack 116, and move out of the rack 116 with the other end effector 118 attached to the spindle 112. The order in which the method blocks are described are not intended to be construed as a limitation, and any number of the described method blocks can be combined in any order to implement a method, or an alternate method.

At block 702, the end effector 114 is attached to the spindle 112. At least one other end effector 118 is stored within the rack 116 and there is at least one empty end effector holder 402 in the rack 116. The robot 102 moves the spindle 112 such that the connection portion 202 is aligned with the slots 506 of the empty end effector holder 402 in front of the empty end effector holder 402. The robot then moves the spindle 112 in the direction of the slots 506 until the indexing features 508 engage the connection portion 202 of the end effector 114.

At block 704, the spindle 112 is raised by the robot 102 to disengage the magnetic attachment features 208 of the end effector 114 from the spindle magnetic attachment features 308 of the spindle 112. The material above the slots 506 keeps the end effector 114 in the rack 116 as the spindle 112 is moved up away from the end effector 114.

At block 706, the spindle 112 is positioned by the robot 102 above the connection portion 202 of another end effector 118 stored within the rack 116.

At block 708, the spindle 112 is lowered by the robot 102 to engage the magnetic attachment features 208 of the other end effector 118 to the spindle magnetic attachment features 308 of the spindle 112.

At block 710, the spindle 112 is moved in the direction of the slots 506 with the other end effector 118 attached and aligned thereto. The indexing features 508 of the end effector holder 402 that held the other end effector 118 move out of the way allowing the other end effector 118 to move out of the rack 116 while attached to the spindle 112.

Although implementations of magnetically attached end effectors have been described in language specific to features and/or methods, the subject of the appended claims is not necessarily limited to the specific features or methods described. Rather, the specific features and methods are disclosed as example implementations of magnetically attached end effectors.

1. An end effector of a touchscreen testing device, the end effector comprising:
a connection portion connectable to a spindle of the touchscreen testing device to test a touchscreen device, the connection portion comprising:
one or more mechanical alignment features effective to align the connection portion to one or more complimentary alignment features of the spindle; and
a magnetic attachment portion effective to removably mount the connection portion to the spindle and maintain the alignment of the alignment features to the complimentary alignment features of the spindle; and
one or more tips connected to the connection portion, each of the tips usable to mimic a human body part when placed proximal to a touchscreen of the touchscreen device.

2. An end effector as recited in claim 1, wherein the magnetic attachment portion comprises one or more magnets affixed to the connection portion effective to mount the connection portion to the spindle.

3. An end effector as recited in claim 1, wherein the spindle contains one or more magnets and the magnetic attachment portion comprises a ferrous material effective to mount the connection portion to the spindle.

4. An end effector as recited in claim 1, wherein the magnetic attachment portion is effective to fix a first and second rotational degrees of freedom and a first translational degree of freedom between the connection portion and the spindle.

5. An end effector as recited in claim 4, wherein the alignment features are effective to fix a third rotational degree of freedom and a second and third translational degrees of freedom between the end effector and the spindle without mechanically securing the end effector to the spindle.

6. An end effector as recited in claim 1, wherein the alignment features comprise one or more of lead-in chamfers, bosses, recesses, pins, tapers, protrusions, or cutouts.

7. An end effector as recited in claim 1, wherein the end effector mimics two or more human fingers.

8. An end effector as recited in claim 1, wherein the end effector comprises two tips that are movable independently of the spindle effective to mimic a pinch or spread gesture.

9. An end effector as recited in claim 1, wherein the connection portion is made of a non-ferrous material.

10. A rack for holding one or more end effectors of a touchscreen testing apparatus, the rack comprising:
a fixed structure mounted to the touchscreen testing apparatus such that a spindle of the touchscreen testing apparatus moves relative to the rack, the movement of the spindle relative to the rack enabling the touchscreen testing apparatus to remove, change, or fix the end effectors to the spindle, the fixed structure comprising one or more end effector holders, each end effector holder comprising:
one or more alignment features that fix an end effector to the rack but allow movement of the end effector relative to the rack in a single direction, the alignment features restricting movement of the end effector in at least a direction normal to the single direction; and
one or more indexing elements that are movably mounted to the rack effective to locate the end effector in the single direction when the end effector is manipulated into the end effector holder in the single direction.

11. A rack as recited in claim 10, wherein the indexing elements comprise ball detents.

12. A rack as recited in claim 11, wherein the removal, changing, or fixing of the end effector to the spindle is accomplished by moving the spindle in three Cartesian coordinates relative to the rack.

13. A rack as recited in claim 12, wherein the alignment features are able to secure the end effector in the rack such that a magnetic attachment of the end effector to the spindle can be overcome by the alignment features in the direction normal to the single direction.

14. A method of magnetically attaching one or more end effectors to a robotic apparatus for touchscreen testing, the method comprising:
storing the end effectors in respective positions on a rack, the rack securing the end effectors in at least a first direction that is normal to a table of the robotic apparatus, each of the end effectors comprising one or more magnetic attachment features and one or more alignment features;
positioning a spindle of the robotic apparatus proximal to a first end effector;
connecting the first end effector to the spindle using the magnetic attachment features, the magnetic attachment features securing the end effector to the spindle in the first direction;
as part of the connecting, aligning the end effector to the spindle using the alignment features, the alignment features matching complimentary alignment features on the spindle;
moving the spindle in a second direction that is not the first direction such that the first end effector is removed from a first position of the rack while still adhered to the spindle; and
utilizing the first end effector to test touchscreen functionality of a touchscreen device placed proximal to the robotic apparatus by the robotic apparatus.

15. A method as described in claim 14, further comprising:
prior to positioning the spindle proximal to the first end effector, the spindle having a second end effector adhered thereto, moving the spindle in the second direction to place the second end effector in a second position in the rack; and
moving the spindle in the first direction effective to disconnect the second end effector from the spindle, the second end effector held in the first direction by the rack.

16. A method as recited in claim 14, wherein the end effectors mimic one or more human digits.

17. A method as recited in claim 14, wherein the rack comprises indexing elements that index the end effectors in the second direction.

18. A method as recited in claim 14, wherein the alignment features comprise one or more of lead-in chamfers, bosses, recesses, pins, tapers, protrusions, or cutouts.

19. A method as recited in claim 15, wherein the disconnection of the second end effector and the connection of the first end effector are done passively by movement of the robotic apparatus in the first and second directions.

20. A method as recited in claim 15, wherein the spindle has complementary magnetic attachment features and the end effectors have different configurations of the magnetic attachment features and alignment features that are able to connect to and align with the complementary alignment features and the complementary magnetic attachment features.
